(19) United States
(12) Patent Application Publication
(10) Pub. No.: US 2018/0335845 A1
(43) Pub. Date: Nov. 22, 2018

(54) CONTROL DEVICE, INPUT SYSTEM AND CONTROL METHOD

(71) Applicant: DENSO TEN Limited, Kobe-shi (JP)

(72) Inventor: Yutaka MATSUNAMI, Kobe-shi (JP)

(73) Assignee: DENSO TEN Limited, Kobe-shi (JP)

(21) Appl. No.: 15/909,251

(22) Filed: Mar. 1, 2018

(30) Foreign Application Priority Data
May 18, 2017 (JP) 2017-099301

(51) Int. Cl. G06F 3/01; G06F 3/16; G06F 3/0354; G06F 3/041

(52) U.S. Cl. CPC G06F 3/016; G06F 3/16; B60K 2350/1028; G06F 3/0416; G06F 2203/014; G06F 3/03547

(57) ABSTRACT

There is provided a control device. An operation detector configured to detect a user's operation on an operation surface of a panel. A driving unit configured to vibrate the panel by driving a vibration element attached to the panel. Wherein when the operation is detected by the operation detector, the driving unit combines a sound signal of sound, which is to be generated from the panel by vibration of the panel, with a drive signal for generating, in the panel, haptic vibration to provide the user with vibration of a haptic sense, and outputs a combined signal to the vibration element, thereby generating the haptic vibration and the sound in the panel.

### CROSS-REFERENCE TO RELATED APPLICATIONS

This application is based on and claims priority under 35 USC 119 from Japanese Patent Application No. 2017-99301 filed on May 18, 2017.

### TECHNICAL FIELD

The present disclosure relates to a control device, an input system and a control method.

### BACKGROUND

In the related art, an input system configured to provide a user with a haptic sense and to thereby enable the user to recognize reception of a user's operation on an operation surface of a panel has been known. In the input system, for example, when the user performs an operation on the operation surface of the panel, a vibration element attached to the panel is caused to vibrate, thereby enabling the user to recognize reception of the input operation (for example, refer to Patent Document 1).

Patent Document 1: JP-A-2013-235614

However, in the input system of the related art, an operational feeling provided for the user is not always sufficient. Therefore, there is room for improvement on the operational feeling provided for the user.

### SUMMARY

It is therefore an object of the disclosure to provide a control device, an input system and a control method capable of improving an operational feeling to be provided for a user.

According to an aspect of the embodiments of the present invention, there is provided a control device including: an operation detector configured to detect a user's operation on an operation surface of a panel, and a driving unit configured to vibrate the panel by driving a vibration element attached to the panel. When the operation is detected by the operation detector, the driving unit combines a sound signal of sound, which is to be generated from the panel by vibration of the panel, with a drive signal for generating, in the panel, haptic vibration to provide the user with vibration of a haptic sense, and outputs a combined signal to the vibration element, thereby generating the haptic vibration and the sound in the panel.

According to the present disclosure, it is possible to improve the operational feeling to be provided for the user.

### BRIEF DESCRIPTION OF THE DRAWINGS

Exemplary embodiments of the present invention will be described in detail based on the following figures, wherein:

FIG. 1 depicts an example where an input system of a first illustrative embodiment is mounted;

FIG. 2 depicts a configuration example of the input system of the first illustrative embodiment;

FIG. 3 depicts an example of vibration of a panel;

FIG. 4 depicts a configuration example of an electronic device system including the input system of the first illustrative embodiment;

FIG. 5 depicts an arrangement example of vibration elements of the first illustrative embodiment;

FIG. 6 is a flowchart depicting an example of a processing sequence that is to be executed by a controller;

FIG. 7 depicts a relation between an input unit and a display device of the electronic device system;

FIG. 8 depicts an example of processing of combining a sound signal with a drive signal for haptic vibration of vibration elements, in a second illustrative embodiment;

FIG. 9 depicts a relation between linear resonance areas and a standing wave formed in the panel;

FIG. 10 depicts a relation between the standing wave and directionality of an operation sound formed in the panel;

FIG. 11 is a flowchart depicting an example of a processing sequence that is to be executed by the controller of a third illustrative embodiment;

FIG. 12 depicts an example of processing of outputting a drive signal for haptic vibration of the vibration elements and a sound signal, in a fourth illustrative embodiment;

FIG. 13 is a flowchart depicting an example of a processing sequence that is to be executed by the controller of the fourth illustrative embodiment;

FIG. 14 depicts a configuration example of an electronic device system including an input system in accordance with a modified embodiment of the fourth illustrative embodiment;

FIG. 15 is a flowchart depicting an example of a processing sequence that is to be executed by the controller in accordance with the modified embodiment of the fourth illustrative embodiment;

FIG. 16 depicts intensities of vibrations that are to be generated in the panel, in the fifth illustrative embodiment; and

FIG. 17 depicts an example of a menu screen that is to be displayed on a display device.

### DETAILED DESCRIPTION

Hereinafter, illustrative embodiments of the control device, the input system and the control method of the present disclosure will be described in detail with reference to the accompanying drawings. In the meantime, the present disclosure is not limited to the illustrative embodiments to be described later.

### First Illustrative Embodiment

<1. Mounting Example of Input System>

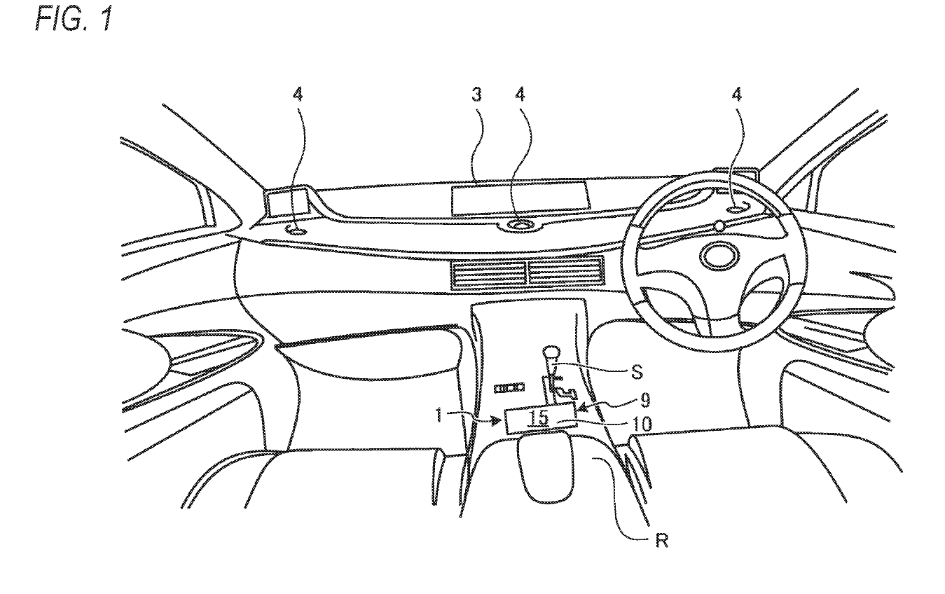

FIG. 1 depicts an example where an input system 1 of a first illustrative embodiment is mounted. As shown in FIG. 1, the input system 1 of the first illustrative embodiment is mounted in a vehicle. However, this is just exemplary and the present disclosure is not limited thereto.

The input system 1 is connected to in-vehicle devices such as a display device 3, speakers 4 and the like via network communication, for example, and is configured to function as an input device of the in-vehicle devices. Also, the input system 1 includes an input unit 9, and the input unit 9 includes a panel 10 such as a touch pad configured to receive a user's input operation.

An operation surface 15 of the panel 10 is arranged at a position at which a driving unit can easily operate the same, such as a part of a center console adjacent to a shift lever S, for example. In the example of FIG. 1, the operation surface 15 is arranged between an arm rest R and the shift lever S. Therefore, the user can operate the operation surface 15 with putting an arm on the arm rest R. Thereby, the user can easily operate the input system 1 without changing a driving posture.

The in-vehicle devices include a variety of devices such as a display device 3 configured to display a predetermined image, speakers 4 configured to output a predetermined voice, an air conditioner, a car navigation system, and the like, for example. Therefore, the user can operate the diverse devices by operating the input system 1.

When an input operation from the user is received, the input system 1 causes the panel 10 to vibrate in association with the input operation. Thereby, the user can recognize that the input operation has been received.

In the meantime, the input system 1 may be configured to output a sound (hereinafter, also referred to as “operation sound”) such as a beep sound, in addition to the vibration of the panel 10, so as to enable the user to recognize reception of the input operation.

However, for example, if the operation sound is configured to be output from the speakers 4, since the input system 1 and the speakers 4 are connected to each other through the network communication, the operation sound may be output with being delayed from the user's input operation, so that the user may feel uncomfortable. Like this, according to the configuration where the operation sound is output from the speakers 4, the operational feeling that is to be provided for the user is not always sufficient.

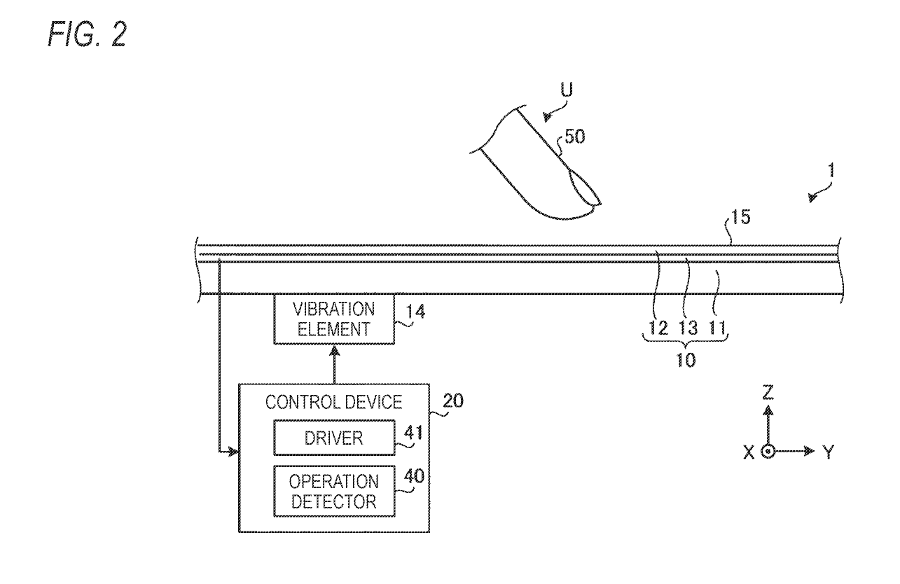

Therefore, the input system 1 of the first illustrative embodiment is configured to enable the user to recognize reception of the input operation without any uncomfortable feeling, so that the operational feeling to be provided for the user can be improved. In the below, the corresponding configuration is described in detail with reference to FIG. 2 and the like.

<2. Control Processing of Input System>

FIG. 2 depicts a configuration example of the input system 1 of the first illustrative embodiment. As shown in FIG. 2, the input system 1 of the first illustrative embodiment includes the panel 10, a vibration element 14, and a control device 20.

The panel 10 includes a support plate 11, a protection layer 12, and a contact sensor 13, in which the contact sensor 13 and the protection layer 12 are stacked in corresponding order on the support plate 11. The protection layer 12 is formed of glass or resin film, for example, and a surface of the protection layer 12 is the operation surface 15 of the panel 10.

The contact sensor 13 is a sensor capable of detecting a contact position (hereinafter, also referred to as ‘user contact position’) of the user U (for example, a finger 50) on the operation surface 15 of the panel 10, and is an electrostatic capacitance-type touch panel, for example. The vibration element 14 is attached to the panel 10, and is configured to vibrate on the basis of a drive voltage that is to be output from the control device 20.

The control device 20 is configured to drive the vibration element 14 and to vibrate the panel 10, in response to an operation of the user U (hereinafter, also referred to as ‘user operation’) on the operation surface 15 of the panel 10. The control device 20 includes an operation detector 40, and a driving unit 41.

The operation detector 40 can detect a user operation, based on a user contact position detected by the contact sensor 13 and a voltage that is to be output from the vibration element 14 in a state where it is not driven by the driving unit 41. The user operation includes a pressing operation of the user U on the operation surface 15, a slide operation of the user U on the operation surface 15, and the like, for example. In the meantime, the pressing operation is an operation of pressing the operation surface 15, and the slide operation is an operation of moving on the operation surface 15 (movement on an XY plane).

The vibration element 14 is an electromechanical conversion element, for example, and is configured to output a voltage corresponding a pressure applied to the panel 10. The operation detector 40 is configured to detect a contact pressure of the user U on the operation surface 15, based on the voltage that is to be output from the vibration element 14 under non-driven state.

The operation detector 40 detects a pressing operation of the user U when the contact pressure of the user U on the operation surface 15 is equal to or higher than a predetermined pressure value. Also, when the user contact position is moved by a predetermined distance or longer, the operation detector 40 detects a slide operation of the user U.

The driving unit 41 is configured to drive the vibration element 14, to vibrate the panel 10 and to thereby generate haptic vibration for providing vibration of a haptic sense for the user U, based on the user operation detected by the operation detector 40. Also, the driving unit 41 is configured to drive the vibration element 14, to vibrate the panel 10 and to thereby generate an operation sound from the panel 10, based on the user operation.

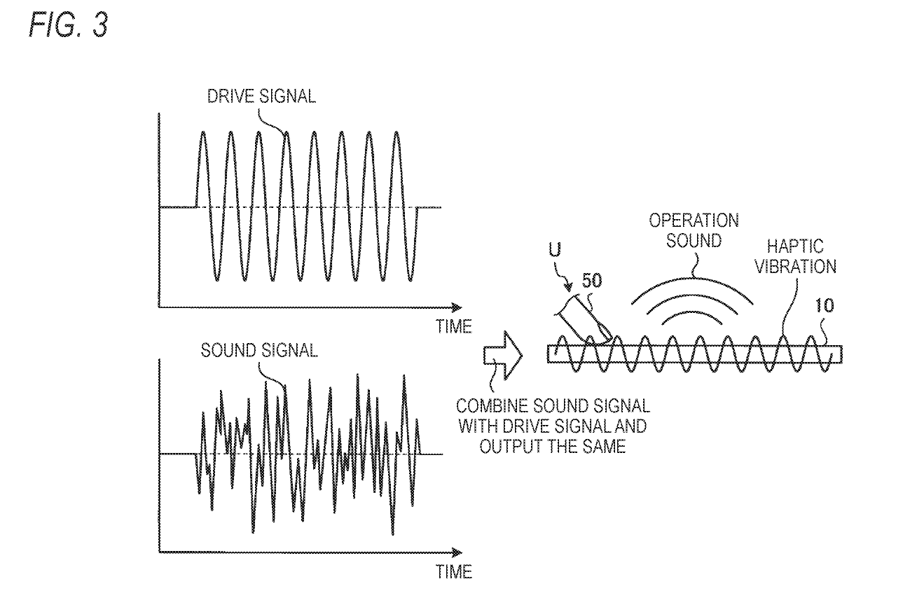

FIG. 3 depicts an example of the vibration of the panel 10. As shown in a left view of FIG. 3, when the user operation is detected by the operation detector 40, the driving unit 41 generates a drive signal for driving the vibration element 14 so that the haptic vibration is to be generated in the panel 10. Also, the driving unit 41 generates a sound signal for operation sound that is to be generated from the panel 10 by the vibration of the panel 10.

The driving unit 41 is configured to combine the sound signal for operation sound with the generated drive signal, and to output the drive signal having the sound signal combined thereto to the vibration element 14. Specifically, the driving unit 41 is configured to apply a voltage, which corresponds to the drive signal having the sound signal combined thereto, to the vibration element 14. The drive voltage is applied to the vibration element 14, so that the vibration element 14 is caused to vibrate and the haptic vibration and operation sound are thus generated in the panel 10, as shown in a right view of FIG. 3.

In this way, when the user operation is detected by the operation detector 40, the driving unit 41 can provide the user U with an operational feeling by the haptic vibration and operation sound (in other words, a haptic operational feeling and an auditory operational feeling), so that it is possible to improve the operational feeling, which is provided for the user U who operates the operation surface 15 of the panel 10.

Also, since the driving unit 41 is configured to combine the sound signal for operation sound with the drive signal for haptic vibration, it is possible to generate the haptic vibration and the operation sound in the panel 10 at the same timing. Thereby, for example, the uncomfortable feeling, which is caused when the operation sound is output with being delayed from the user operation, is not provided to the user U. That is, in the first illustrative embodiment, it is possible to enable the user U to recognize reception of the input operation without any uncomfortable feeling, thereby improving the operational feeling that is to be provided for the user U.

<3. Configuration of Electronic Device System>

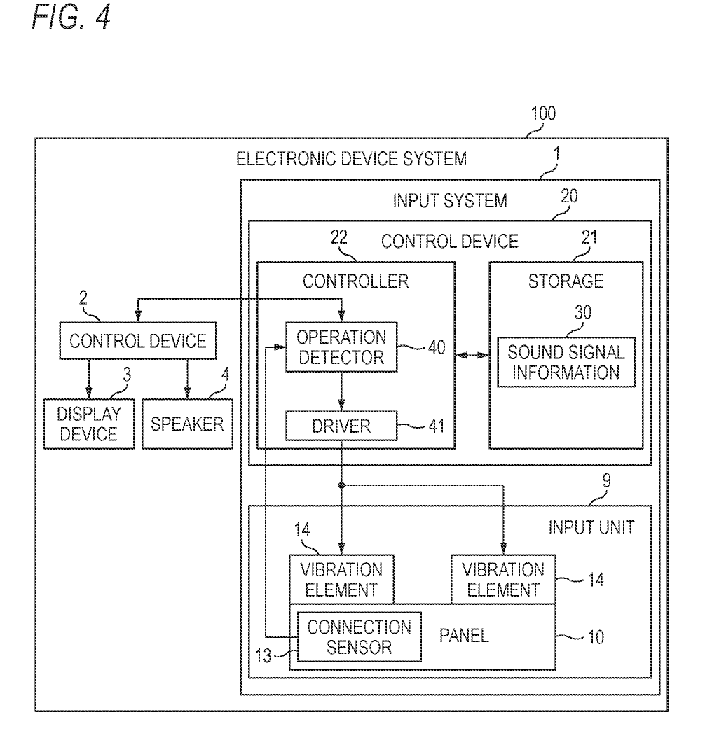

FIG. 4 depicts a configuration example of an electronic device system 100 including the input system 1 of the first illustrative embodiment. The electronic device system 100 shown in FIG. 4 is an in-vehicle system that is to be mounted in a vehicle, for example. However, the present disclosure is not limited thereto. For example, the electronic device system 100 may be a computer system including a PC (Personal Computer), and the like.

As shown in FIG. 4, the electronic device system 100 includes the input system 1, a control device 2, the display device 3, and the speakers 4. The input system 1 is configured to receive a user operation, and to notify information indicative of the user operation to the control device 2. The control device 2 is configured to control a screen that is to be displayed on the display device 3, in response to the user operation. Also, when an audio is selected from the diverse in-vehicle devices by the user operation, for example, the control device 2 outputs a voice, a music and the like of the audio from the speakers 4.

The input system 1 includes the input unit 9 and the control device 20. As described above, the input unit 9 includes the panel 10, and vibration elements 14. In the meantime, the contact sensor 13 of the panel 10 is a sensor that can detect the contact position of the user U on the operation surface 15 of the panel 10, and is an electrostatic capacitance-type touch panel, as described above. However, the contact sensor 13 may be any contact sensor, other than the electrostatic capacitance-type touch panel. For example, when detecting the contact pressure of the user U on the operation surface 15 of the panel 10 by the contact sensor 13, a resistance pressure-sensitive touch sensor may be used as the contact sensor 13.

The vibration elements 14 are attached to a front surface or a back surface of the panel 10. The vibration element 14 is a piezoelectric element, for example. However, when the contact sensor 13 is configured as a pressure-sensitive sensor, instead of detecting a pressure of the user operation on the operation surface 15 of the panel 10 by the vibration elements 14, the vibration element 14 may be a linear resonance actuator, or the like. In the meantime, although not shown, the input unit 9 may include an amplifier configured to amplify a drive voltage, which is to be output from the control device 20, and to output the amplified voltage to the vibration element 14.

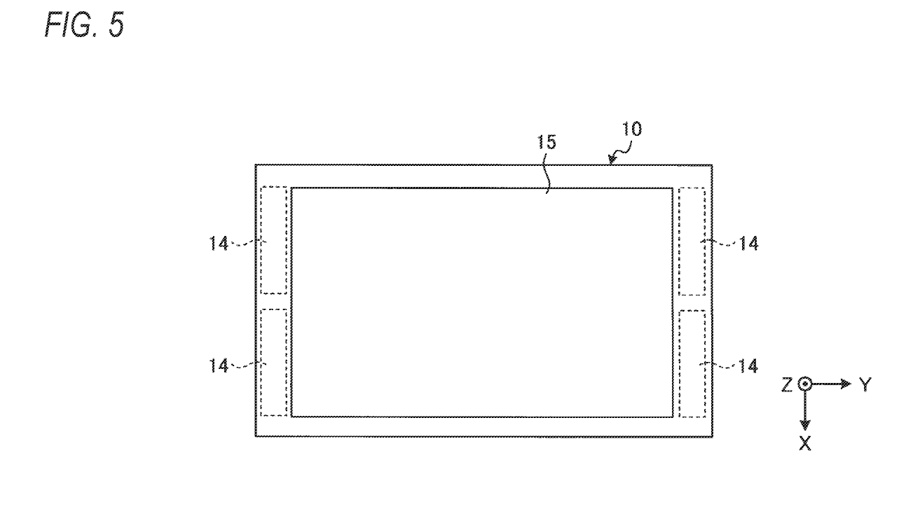

FIG. 5 depicts an arrangement example of the vibration elements 14 of the first illustrative embodiment. In the example of FIG. 5, the input unit 9 includes the four vibration elements 14. The four vibration elements 14 are arranged two by two at both end portions of the panel 10. In the meantime, the number of the vibration elements 14 is not limited to four, and may be three or less or five or more. For example, the vibration elements 14 may be arranged one by one at both end portions of the panel 10.

Returning to FIG. 4, the control device 20 includes a storage 21 and a controller 22. In the storage 21, sound signal information 30 is stored. The sound signal information 30 is information that is used to generate the sound signal for operation sound.

Specifically, the sound signal information 30 is information relating to a sound signal for operation sound (for example, beep sound and the like) corresponding to the user operation. In the meantime, the sound signal information 30 may include information relating to sound signals for many types of operation sounds, in correspondence to types of the user operation. For example, a sound signal for operation sound, which provides the user U with a click feeling such as “click” when the user operation is a pressing operation, a sound signal for operation sound, which provides the user U with a feeling as if the finger 50 is sucked in a slide direction when the user operation is a slide operation, and the like may be included in the sound signal information 30.

The controller 22 includes the operation detector 40 and the driving unit 41. The operation detector 40 is configured to acquire detection information indicative of a contact position of the user U on the operation surface 15, which is detected by the contact sensor 13. Also, the operation detector 40 is configured to acquire a value of an output voltage, which is to be output from the vibration element 14 in a state where it is not driven by the driving unit 41, and to detect a contact pressure of the user U on the operation surface 15 on the basis of the value of the output voltage.

The operation detector 40 is configured to detect the user operation, based on the information acquired from the contact sensor 13 and the detected contact pressure. Specifically, the operation detector 40 can detect a variety of user operations such as a pressing operation and a slide operation of the user U on the operation surface 15. In the meantime, when the contact sensor 13 is a pressure-sensitive sensor, the operation detector 40 may acquire the information indicative of the contact pressure of the user U on the operation surface 15 from the contact sensor 13, without using the output voltage of the vibration elements 14.

When the contact position of the user U on the operation surface 15 is kept at the same position and the contact pressure is equal to or higher than a predetermined pressure value, the operation detector 40 may determine that there is a pressing operation of the user U on the operation surface 15.

Also, when the contact position of the user U on the operation surface 15 is moved by a predetermined distance or longer in a state where the contact pressure of the user U on the operation surface 15 is equal to or higher than a predetermined pressure value, the operation detector 40 may determine that there is a slide operation of the user U on the operation surface 15. In the meantime, the operation detector 40 may determine that there is a slide operation when the contact position is moved by the predetermined distance or longer, irrespective of the contact pressure.

When the slide operation or the pressing operation is detected by the operation detector 40, the driving unit 41 drives the vibration elements 14 to generate a haptic vibration and an operation sound in the panel 10.

For example, when a slide operation is detected by the operation detector 40, the driving unit 41 may vibrate the vibration element 14 with a high frequency of an ultrasonic band. Specifically, when the slide operation is detected, the driving unit 41 generates a drive signal for ultrasonic vibration of the vibration elements 14. Also, the driving unit 41 reads the sound signal information 30, and generates a sound signal for operation sound corresponding to the slide operation.

The driving unit 41 is configured to superimpose and combine the sound signal for operation sound corresponding to the slide operation with the drive signal for ultrasonic vibration of the vibration elements 14. Like this, the driving unit 41 is configured to effectively combine the sound signal with the drive signal by superimposing the sound signal on the drive signal.

The driving unit 41 is configured to apply a drive voltage, which corresponds to the drive signal having the sound signal combined thereto, to the vibration elements 14. The drive voltage is a sinusoidal wave voltage having a high frequency (for example, 30 kHz) of the ultrasonic band. The drive voltage is applied to each vibration element 14, so that each vibration element 14 is caused to vibrate with a frequency of the ultrasonic band and an ultrasonic vibration is generated in the panel 10, as a haptic vibration.

The panel 10 is ultrasonically vibrated, so that it is possible to reduce a frictional force of the operation surface 15 against the user U by using a squeeze effect.

The squeeze effect indicates a phenomenon that, when the operation surface 15 is caused to ultrasonically vibrate by the vibration element 14, an air layer is formed by the air introduced between the finger 50 (refer to FIG. 2) of the user U and the operation surface 15 (refer to FIG. 2) due to pressure variation resulting from the vibration and a frictional resistance between the finger 50 of the user U and the operation surface 15 is thus relatively reduced, as compared to a case where there is no vibration.

Like this, since the frictional force of the operation surface 15 of the panel 10 is reduced, it is possible to provide a smooth haptic sense as if the finger 50 is sucked in a slide direction of the slide operation of the user U of moving the finger 50 on the operation surface 15 of the panel 10, so that it is possible to improve the operational feeling, which is to be provided for the user U.

Also, since the drive signal is combined with the sound signal, the operation sound corresponding to the slide operation is also generated from the panel 10, in addition to the ultrasonic vibration.

Like this, in the first illustrative embodiment, when the slide operation is detected as the user operation, it is possible to generate the haptic vibration and operation sound corresponding to the slide operation in the panel 10. Thereby, it is possible to improve the operational feeling, which is to be provided for the user U who operates the operation surface 15 of the panel 10.

Also, for example, when the pressing operation is detected by the operation detector 40, the driving unit 41 can cause the vibration elements 14 to vibrate with a low frequency lower than the high frequency of the ultrasonic band. Specifically, when the pressing operation is detected, the driving unit 41 generates the drive signal for causing the vibration elements 14 to vibrate with the low frequency. Also, the driving unit 41 reads the sound signal information 30, and generates the sound signal for operation sound corresponding to the pressing operation.

Then, the driving unit 41 superimposes and combines the sound signal for operation sound corresponding to the pressing operation with the drive signal for low frequency vibration of the vibration elements 14. The driving unit 41 applies a drive voltage corresponding to the drive signal having the sound signal combined thereto to the vibration elements 14.

The drive voltage is a sinusoidal wave voltage having a frequency (for example, a frequency of 200 Hz or lower) of a low frequency band lower than the ultrasonic band. The drive voltage is applied to each vibration element 14, so that each vibration element 14 is caused to vibrate with a frequency of the low frequency band and the low frequency vibration is thus generated in the panel 10, as the haptic vibration. Thereby, the driving unit 41 can provide with the user with the click feeling such as “click”, for example, so that it is possible to improve the operational feeling, which is to be provided for the user U.

Also, since the drive signal is combined with the sound signal, the operation sound corresponding to the pressing operation is also generated from the panel 10, in addition to the low frequency vibration. In this way, in the first illustrative embodiment, when the pressing operation is detected as the user operation, it is possible to generate the haptic vibration and operation sound corresponding to the pressing operation in the panel 10. Thereby, it is possible to improve the operational feeling, which is to be provided for the user U.

Meanwhile, in the above example, the vibration aspect of the panel 10 such as the ultrasonic vibration and the low frequency vibration and the operation sound are different, depending on whether the user operation is the slide operation or the pressing operation. However, the present disclosure is not limited thereto. For example, the same vibration aspect and the same operation sound may be made.

<4. Processing that is to be Executed by Control Device of Input System>

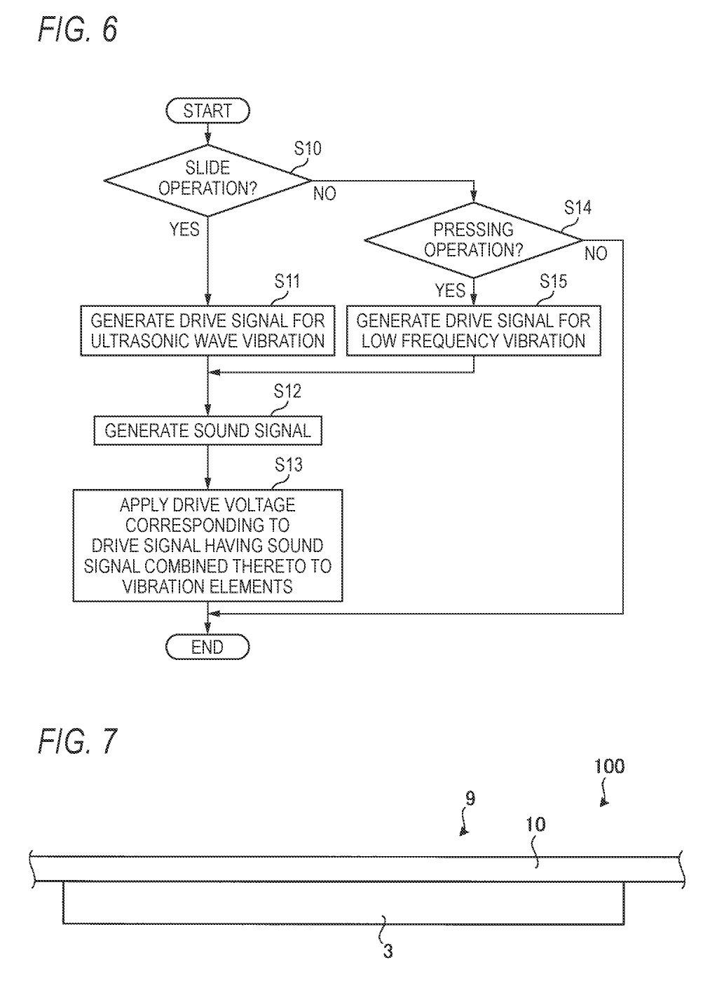

Subsequently, an example of a processing sequence that is to be executed by the controller 22 of the control device 20 is described. FIG. 6 is a flowchart depicting an example of a processing sequence that is to be repetitively executed by the controller 22.

As shown in FIG. 6, the controller 22 determines whether there is a slide operation of the user U (step S10). When it is determined that there is a slide operation (step S10, Yes), the controller 22 generates a drive signal for ultrasonic vibration of the vibration elements 14 (step S11).

Continuously, the controller 22 generates a sound signal for operation sound corresponding to the user operation (here, the slide operation) (step S12). The controller 22 combines the sound signal for operation sound with the drive signal for ultrasonic vibration of the vibration elements 14, and applies a drive voltage, which corresponds to the drive signal having the sound signal combined thereto, to the vibration elements 14 (step S13). Thereby, the ultrasonic vibration and operation sound for the haptic sense of the user U are generated in the panel 10.

On the other hand, when it is determined that there is no slide operation (step S10, No), the controller 22 determines whether there is a pressing operation of the user U (step S14). When it is determined that there is a pressing operation (step S14, Yes), the controller 22 generates a drive signal for low frequency vibration of the vibration elements 14 (step S15).

Like the case of the slide operation, the controller 22 generates a sound signal for operation sound corresponding to the user operation (here, the pressing operation) (step S12), and applies a drive voltage, which corresponds to the drive signal for the low frequency vibration having the sound signal combined thereto, to the vibration elements 14 (step S13). Thereby, the low frequency vibration and operation sound for the haptic sense of the user U are generated in the panel 10. On the other hand, when it is determined in step S14 that there is no pressing operation of the user U (step S14, No), the controller 22 repeats the processing from step S10.

As described above, the control device 20 of the first illustrative embodiment includes the operation detector 40 and the driving unit 41. The operation detector 40 is configured to detect the operation of the user U on the operation surface 15 of the panel 10. The driving unit 41 is configured to drive the vibration elements 14 attached to the panel 10, thereby generating the vibration in the panel 10. Also, when an operation is detected by the operation detector 40, the driving unit 41 combines the sound signal of a sound, which is to be generated from the panel 10 by the vibration of the panel 10, with the drive signal for generating the haptic vibration, which provides the user U with the haptic vibration, in the panel 10, outputs the combined signal to the vibration elements 14, and generates the haptic vibration and sound in the panel. Thereby, it is possible to improve the operational feeling that is to be provided for the user U.

In the meantime, in the electronic device system 100, the input unit 9 and the display device 3 are arranged with being spaced from each other (refer to FIG. 1). However, the present disclosure is not limited thereto. That is, as shown in FIG. 7, the electronic device system 100 may include a touch panel display in which the input unit 9 and the display device 3 are integrated.

FIG. 7 depicts a relation between the input unit 9 and the display device 3 of the electronic device system 100. As shown in FIG. 7, the display device 3 is arranged on a back surface of the panel 10, so that the user U can see a screen displayed on the display device 3 via the panel 10.

In the meantime, in the example of FIG. 4, the control device 2 and the control device 20 are separately configured. However, the functions of the control device 2 may be added to the control device 20. In this case, the control device 2 is connected to the input unit 9 and the display device 3, and can display, on the display device 3, a screen corresponding to an operation on the input unit 9.

### Second Illustrative Embodiment

Subsequently, a second illustrative embodiment is described. Meanwhile, in the below, the common configurations to the first illustrative embodiment are denoted with the same reference numerals, and the descriptions thereof are omitted.

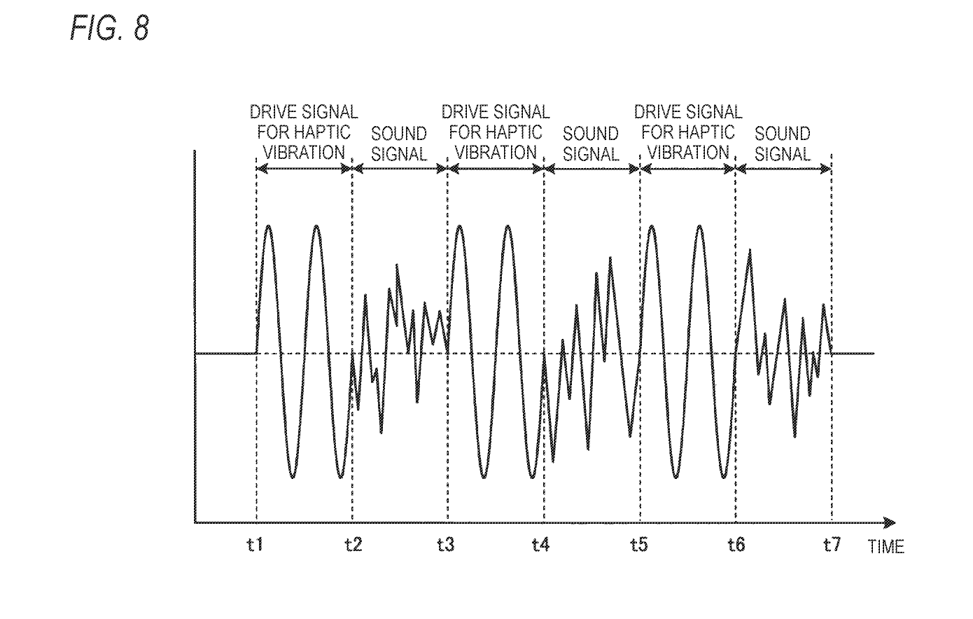

FIG. 8 depicts an example of processing of combining a sound signal with a drive signal for haptic vibration of the vibration elements 14. As shown in FIG. 8, the driving unit 41 of the second illustrative embodiment is configured to alternately output a drive signal for haptic vibration and a sound signal to the vibration element 14 for combining the drive signal and the sound signal.

Specifically, the driving unit 41 is configured to divide a drive signal for haptic vibration and a sound signal, and to alternately output the divided drive signal and sound signal to the vibration element 14. Specifically, the driving unit 41 outputs the drive signal for haptic vibration to the vibration element 14, specifically applies a drive voltage corresponding to the drive signal for haptic vibration to the vibration element 14 from time t1 to time t2. The drive voltage is applied to the vibration element 14, so that the vibration element 14 is caused to haptically vibrate and the haptic vibration is thus generated in the panel 10.

The driving unit 41 outputs the sound signal to the vibration element 14 from time t2 to time t3, and more specifically, applies a drive voltage corresponding to the sound signal to the vibration element 14. The drive voltage is applied to the vibration element 14, so that the vibration element 14 is caused to vibrate and the operation sound is generated from the panel 10.

From time t3 to time t7, the driving unit 41 alternately outputs the drive signal for haptic vibration and the sound signal to the vibration element 14. In this way, in the second illustrative embodiment, the drive signal for haptic vibration and the sound signal are switched in a time division manner.

Also, in the second illustrative embodiment, a period in which the drive signal for haptic vibration and the sound signal are switched is set to be relatively short, so that the haptic vibration and the operation sound can be generated in the panel 10 at the same timing. Thereby, in the second illustrative embodiment, it is possible to enable the user U to recognize reception of the input operation without the uncomfortable feeling, thereby improving the operational feeling that is to be provided for the user U.

### Third Illustrative Embodiment

Subsequently, a third illustrative embodiment is described. In the third illustrative embodiment, when ultrasonically vibrating the panel 10 to generate the haptic vibration, the sound signal is combined with the drive signal by modulating the drive signal for ultrasonic vibration with the sound signal for operation sound.

Thereby, in the third illustrative embodiment, it is possible to generate the operation sound in a specific direction, i.e., to output the operation sound of high directionality while generating the haptic vibration.

Here, the operation sound of high directionality is described. The input system 1 (refer to FIG. 4) of the third illustrative embodiment is configured to generate an ultrasonic wave corresponding to a carrier wave modulated with the sound signal, thereby the operation sound of high directionality.

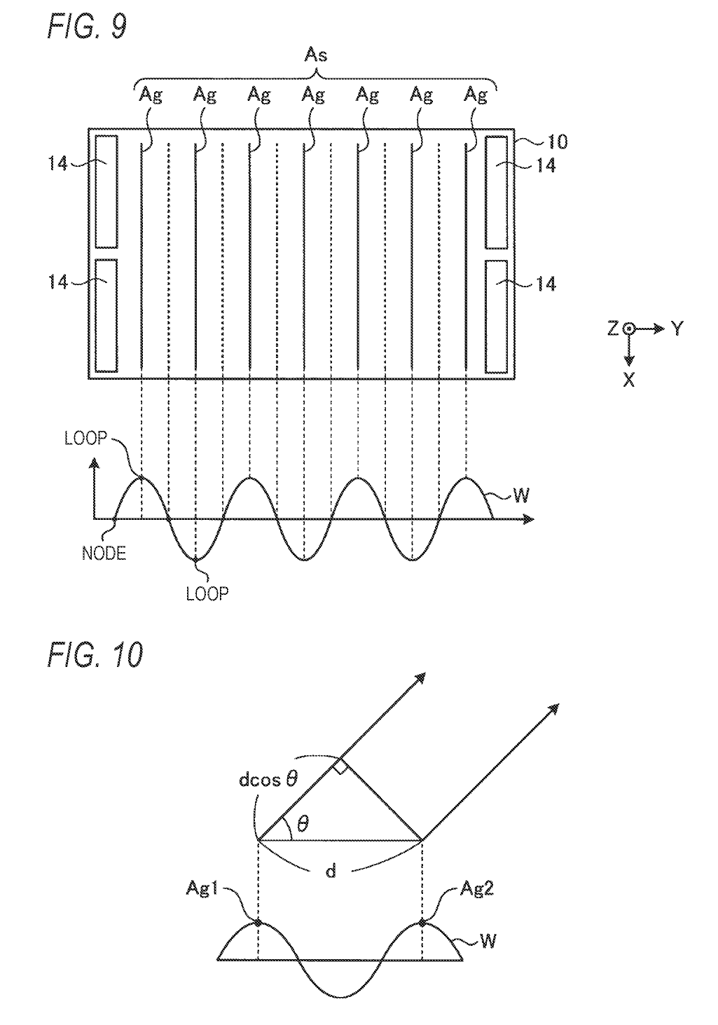

Specifically, the driving unit 41 of the third illustrative embodiment is configured to generate a carrier wave of an ultrasonic band. The carrier wave is a sinusoidal wave signal of the ultrasonic band, has a frequency of generating a standing wave W (refer to FIG. 9) and forming a stripe-shaped resonance area As (refer to FIG. 9) in the panel 10. In the meantime, ultrasonic wave vibration, which is the haptic vibration, is generated by the standing wave W generated in the panel 10.

The driving unit 41 is configured to generate a modulated signal, which is a signal obtained by modulating the generated carrier wave with the sound signal. The modulation is performed by AM (Amplitude Modulation) modulation, for example. In the meantime, the AM modulation is DSB (Double Sideband) modulation or SSB (Single Side band) modulation, for example. Also, the driving unit 41 may be configured to amplify the modulated signal.

The driving unit 41 is configured to apply an alternating current voltage corresponding to a waveform of the modulated signal to each vibration element 14, as the drive voltage. The drive voltage is applied to the vibration elements 14, so that the standing wave W is generated in the panel 10. Thereby, a stripe-shaped resonance area As is formed in the panel 10, so that linear resonance areas Ag (refer to FIG. 9), in which loops of the standing wave W are included in the resonance area As, is formed.

FIG. 9 depicts a relation between the linear resonance areas Ag and the standing wave formed in the panel 10. In FIG. 9, the loops of the standing wave W are shown with solid lines, nodes of the standing wave W are shown with broken lines, and the loops of the standing wave W function as the linear resonance areas Ag. The linear resonance area Ag functions as a linear sound source of emitting an ultrasonic wave modulated by the sound signal for operation sound.

Subsequently, the directionality of the operation sound generated from the panel 10 is described with reference to FIG. 10. FIG. 10 depicts a relation between the standing wave W and the directionality of the operation sound generated from the panel 10. In FIG. 10, in order to easily understand the descriptions, the standing wave W is partially shown. Also, the loops of the standing wave W, which have the same phase and are adjacent to each other, are shown as linear resonance areas Ag1, Ag2, and an angle θ of an ultrasonic wave, which is generated from each of the linear resonance areas Ag1, Ag2, relative to the panel 10 is shown.

At any angle θ, the phases of the ultrasonic waves generated from the linear resonance areas Ag1, Ag2 are offset by a distance d cos θ. When a wavelength of the carrier wave is denoted as λ, the ultrasonic waves generated from the linear resonance areas Ag1, Ag2 are cancelled at an angle θ at which the distance d cos θ is an odd multiple of a wavelength λ/2. That is, the ultrasonic waves are cancelled at the angle θ at which the distance d cos θ is an odd multiple of a wavelength λ/2. On the other hand, at an angle θ at which the distance d cos θ is an integral multiple of the wavelength λ (an even multiple of the wavelength λ/2), the ultrasonic waves generated from the linear resonance areas Ag1, Ag2 are reinforced. Then, sonic waves of an audible wave band are generated by a natural demodulation phenomenon resulting from nonlinear distortion of the ultrasonic waves when the ultrasonic waves are spread in a space or when the ultrasonic waves are reflected on a rigid body.

In this way, the ultrasonic waves generated from the linear resonance areas Ag phase-interfere each other (reinforcement and cancellation), so that the ultrasonic waves can travel in a specific direction. The sonic waves of the audible wave band are generated by the natural demodulation phenomenon resulting from the nonlinear distortion of the ultrasonic waves, so that the operation sound of high directionality is generated from the panel 10.

Thereby, in the third illustrative embodiment, it is possible to generate the operation sound in a direction of the specific user U such as a driving unit, for example, while generating the haptic vibration in the panel 10.

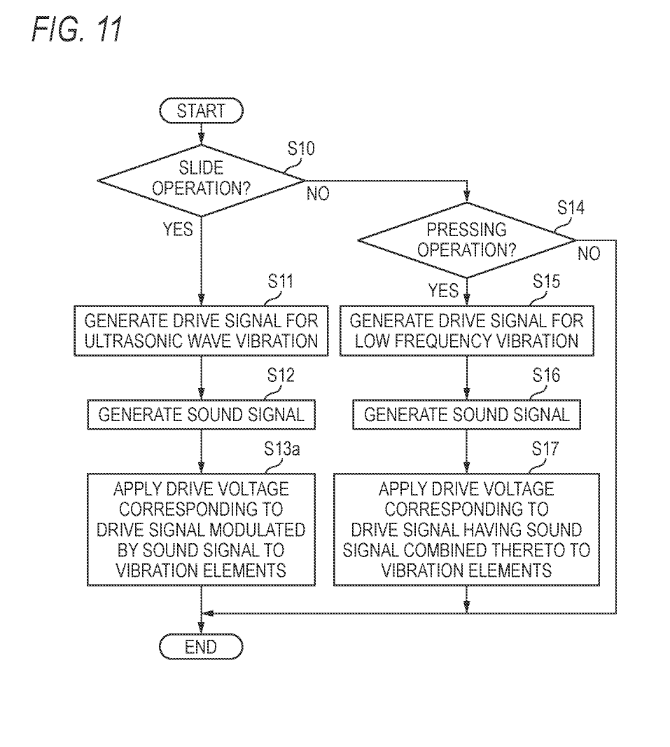

FIG. 11 is a flowchart depicting an example of a processing sequence that is to be executed by the controller 22 of the third illustrative embodiment.

As shown in FIG. 11, the controller 22 generates the drive signal for ultrasonic vibration of the vibration elements 14 and the sound signal for operation sound, through steps S10 to S12. Then, the controller 22 modulates the drive signal by the sound signal for operation sound to combine the sound signal with the drive signal, and applies the drive voltage corresponding to the drive signal modulated by the sound signal to the vibration elements 14 (step S13a). Thereby, the ultrasonic vibration for haptic sense of the user U and the operation sound of high directionality are generated in the panel 10.

On the other hand, the controller 22 generates the drive signal for low frequency vibration of the vibration elements 14 in correspondence to the pressing operation, through steps S10, S14 and S15. Then, the controller 22 generates the sound signal for operation sound corresponding to the pressing operation (step S16), and applies the drive voltage corresponding to the drive signal for low frequency vibration having the sound signal combined thereto to the vibration elements 14 (step S17). Thereby, the low frequency vibration for haptic sense of the user U and the operation sound of high directionality are generated in the panel 10.

### Fourth Illustrative Embodiment

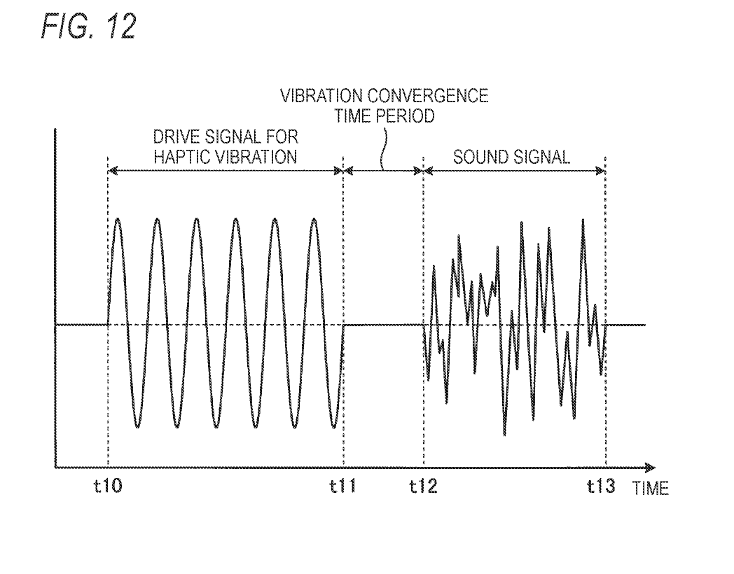

Subsequently, a fourth illustrative embodiment is described. FIG. 12 depicts an example of processing of outputting a drive signal for haptic vibration of the vibration elements 14 and a sound signal, in a fourth illustrative embodiment. As shown in FIG. 12, the driving unit 41 of the fourth illustrative embodiment outputs the drive signal for haptic vibration to the vibration elements 14 from time t10 to time t11. Thereby, the haptic vibration is generated in the panel 10.

When the haptic vibration is over at time t11, the driving unit 41 waits until a vibration convergence time period elapses. In the meantime, the vibration convergence time period is a time period in which it is expected that the vibration of the panel 10 under haptic vibration is to be converged. The vibration convergence time period may be a fixed value or a variable value, as described later, for example. In the meantime, the vibration convergence time period is a very short time such as several msec to several tens of msec. In the meantime, the vibration convergence time period is an example of the predetermined time.

When the vibration convergence time period elapses (time t12), the driving unit 41 outputs the sound signal to the vibration elements 14 from time t12 to t13. Thereby, the vibration elements 14 are caused to vibrate, and the operation sound is generated in the panel 10.

In this way, according to the fourth illustrative embodiment, after generating the haptic vibration, the operation sound is continuously generated. Therefore, it is possible to enable the user U to recognize reception of the input operation without the uncomfortable feeling, thereby improving the operational feeling that is to be provided for the user U.

Also, in the fourth illustrative embodiment, when the vibration convergence time period elapses after the haptic vibration is over, the panel 10 is vibrated to generate the operation sound. That is, according to the fourth illustrative embodiment, since the vibration of the operation sound is generated in the panel 10 in which the haptic vibration has stopped, it is possible to suppress an influence of the haptic vibration on the vibration of generating the operation sound.

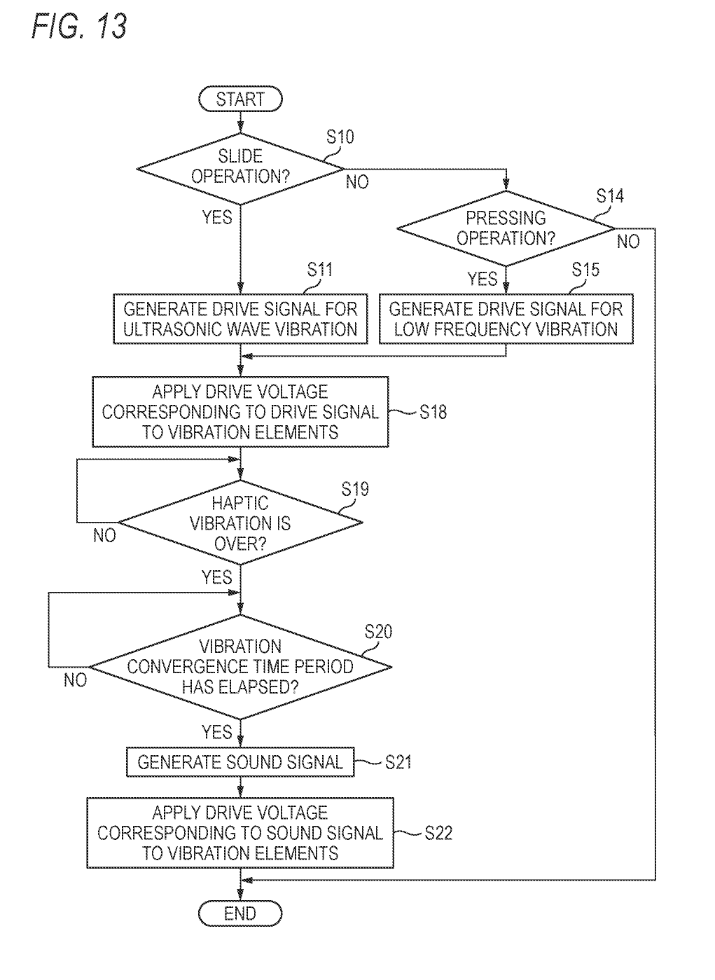

FIG. 13 is a flowchart depicting an example of a processing sequence that is to be executed by the controller 22 of the fourth illustrative embodiment. As shown in FIG. 13, in the case of the slide operation, the controller 22 generates the drive signal for ultrasonic vibration of the vibration elements 14 via the processing of steps S10 and S11. On the other hand, in the case of the pressing operation, the controller 22 generates the drive signal for low frequency vibration of the vibration elements 14 via the processing of steps S10, S14 and S15.

Then, the controller 22 applies the drive voltage corresponding to the generated drive signal to the vibration elements 14 (step S18). Thereby, the ultrasonic vibration or low frequency vibration is generated as the haptic vibration in the panel 10.

Continuously, the controller 22 determines whether the haptic vibration is over (step S19). Specifically, the controller 22 determines whether the output of the drive signal is over. When it is determined that the haptic vibration is not over (step S19, No), the controller 22 repeats the processing of step S19. On the other hand, when it is determined that the haptic vibration is over (step S19, Yes), the controller 22 determines whether the vibration convergence time period has elapsed (step S20).

When it is determined that the vibration convergence time period has not elapsed (step S20, No), the controller 22 repeats the processing of step S20. On the other hand, when it is determined that the vibration convergence time period has elapsed (step S20, Yes), the controller 22 generates the sound signal corresponding to the user operation (step S21). Then, the controller 22 applies the drive voltage corresponding to the sound signal to the vibration elements 14 (step S22). Thereby, the operation sound is generated in the panel 10.

Meanwhile, in the above description, the controller 22 is configured to generate the sound signal after the vibration convergence time period elapses. However, the present disclosure is not limited thereto. For example, the controller 22 may be configured to generate the sound signal before the vibration convergence time period elapses.

### Modified Embodiment of Fourth Illustrative Embodiment

Subsequently, a modified embodiment of the fourth illustrative embodiment is described. In the modified embodiment, for example, a vibration state of the panel 10 is detected, and the vibration convergence time period is set and changed in correspondence to the detected vibration state.

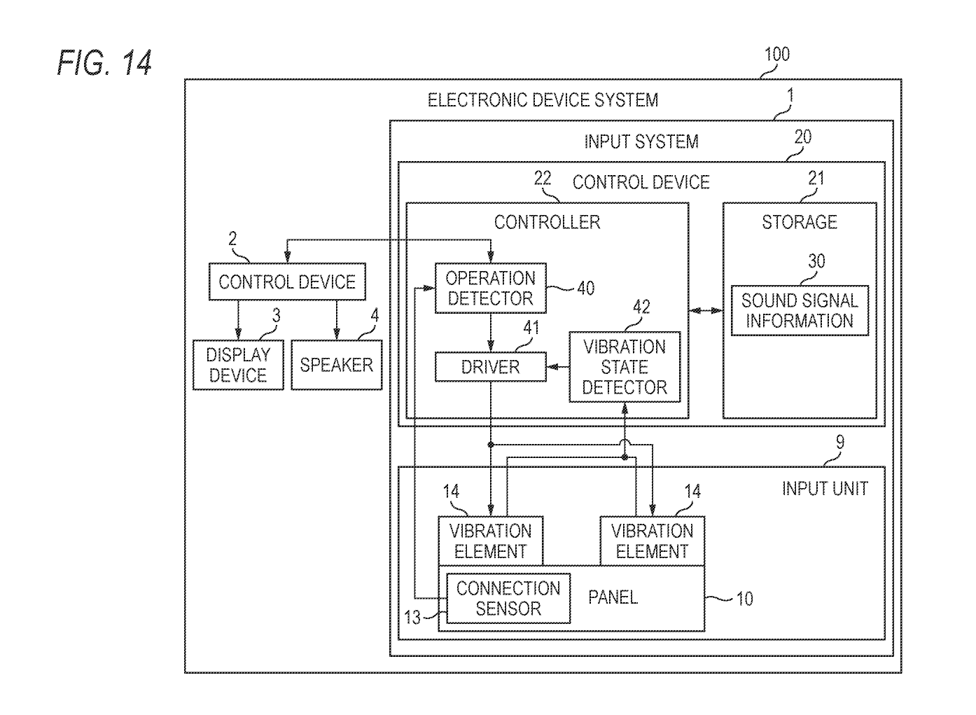

The modified embodiment of the fourth illustrative embodiment is described with reference to FIG. 14. FIG. 14 depicts a configuration example of the electronic device system 100 including the input system 1 in accordance with the modified embodiment of the fourth illustrative embodiment. As shown in FIG. 14, according to the modified embodiment of the fourth illustrative embodiment, the controller 22 includes a vibration state detector 42.

Meanwhile, in this modified embodiment, a piezoelectric element is used as the vibration element 14. When the drive signal for haptic vibration is not input, the vibration element 14 converts the haptic vibration remaining in the panel 10 into a voltage by a piezoelectric effect. The voltage indicative of the haptic vibration remaining in the panel 10 is input from the vibration element 14 into the vibration state detector 42.

The vibration state detector 42 is configured to detect a vibration state of the panel 10 such as whether there is the haptic vibration remaining in the panel 10, an intensity of the haptic vibration, and the like, based on the input voltage. The vibration state detector 42 is configured to output a signal indicative of the detected vibration state of the panel 10 to the driving unit 41.

The driving unit 41 is configured to set the vibration convergence time period, based on the vibration state of the panel 10. Specifically, when an intensity of the haptic vibration remaining in the panel 10 is relatively high, the vibration state detector 42 may set the vibration convergence time period to be long. On the other hand, when an intensity of the haptic vibration remaining in the panel 10 is relatively low, the vibration state detector 42 may set the vibration convergence time period to be short.

Also, the vibration state detector 42 may be input with the signal indicative of the vibration state of the panel 10, even after the vibration convergence time period is set. Although the haptic vibration remaining in the panel 10 converges over time, the vibration state detector 42 may change the vibration convergence time period to a long time period when the haptic vibration does not converge more than prediction and the vibration intensity is kept at the relatively high state, for example. In the meantime, when the haptic vibration is stopped earlier than prediction and the vibration intensity becomes relatively low, the vibration state detector 42 may change the vibration convergence time period to a short time, for example.

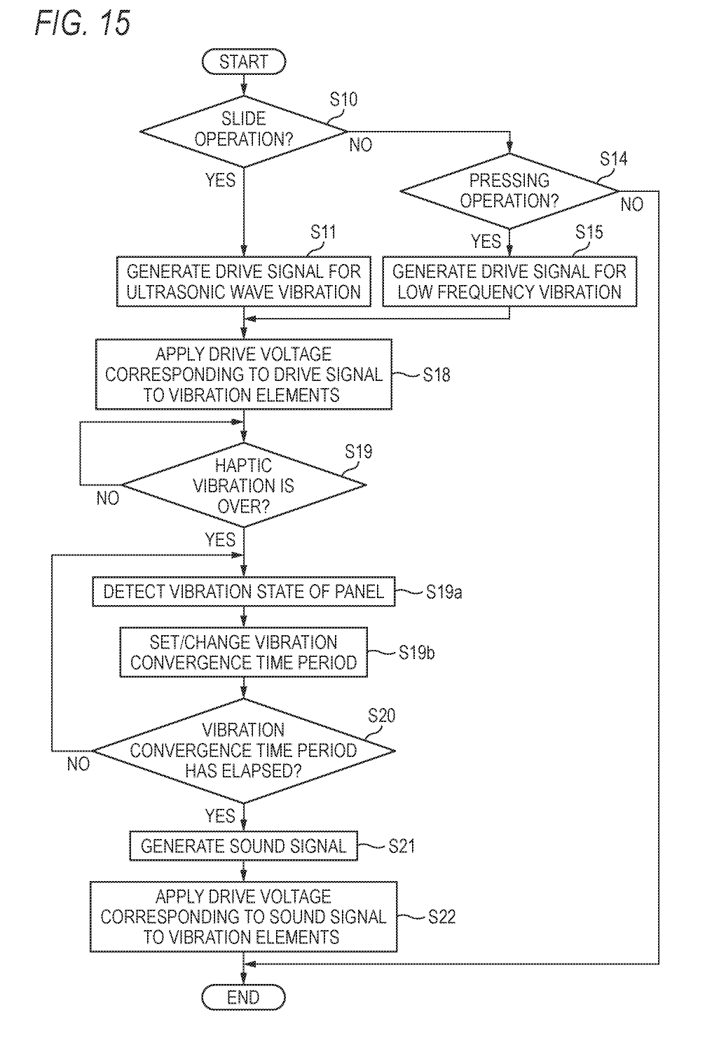

FIG. 15 is a flowchart depicting an example of a processing sequence that is to be executed by the controller 22 in accordance with the modified embodiment of the fourth illustrative embodiment. As shown in FIG. 15, the controller 22 generates the haptic vibration in the panel 10 via steps S10, S11 and S18 or steps S10, S14, S15 and S18. Then, when it is determined that the haptic vibration is over (step S19, Yes), the controller 22 detects the vibration state of the panel 10 (step S19a).

Continuously, the controller 22 sets the vibration convergence time period, based on the detected vibration state of the panel 10 (step S19b). Then, the controller 22 determines whether the vibration convergence time period has elapsed (step S20). When it is determined that the vibration convergence time period has not elapsed (step S20, No), the controller 22 repeats the processing of steps S19a and S19b, and appropriately changes the vibration convergence time period on the basis of the vibration state of the panel 10.

When it is determined that the set or changed vibration convergence time period has elapsed (step S20, Yes), the controller 22 executes the processing of steps S21 and S22 and generates the operation sound from the panel 10.

Thereby, in the modified embodiment of the fourth illustrative embodiment, for example, it is possible to detect the vibration state of the panel 10, and to generate the vibration of the operation sound in the panel 10 in which the haptic vibration has stopped. Accordingly, it is possible to effectively suppress an influence of the haptic vibration on the vibration of generating the operation sound.

### Fifth Illustrative Embodiment

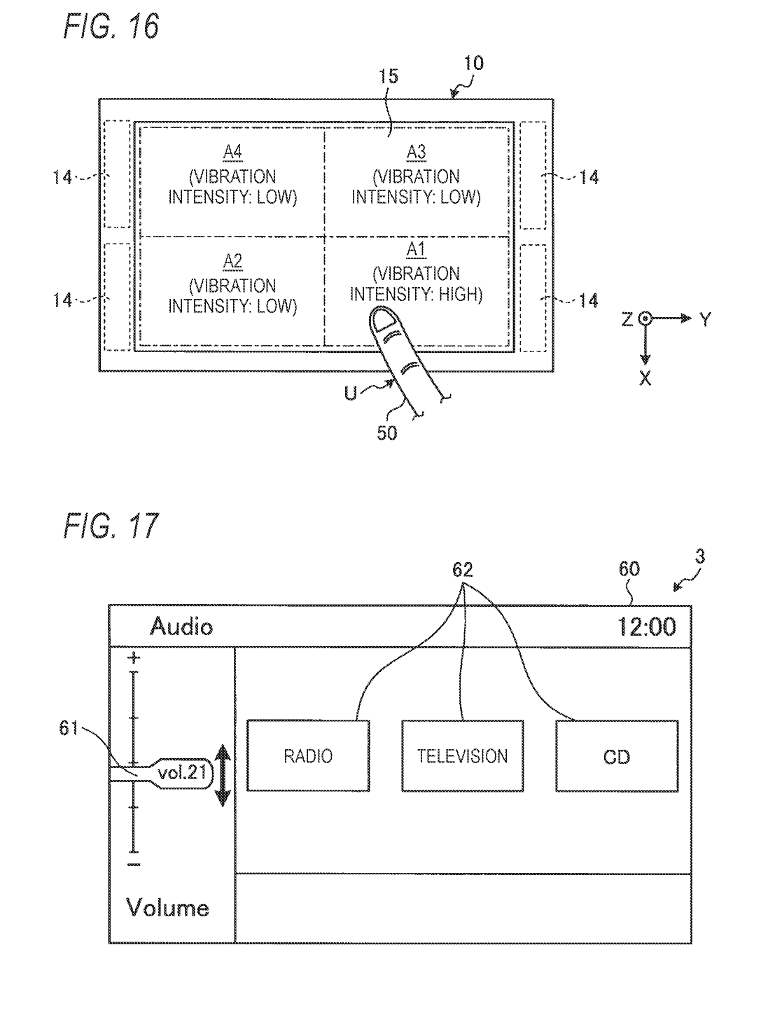

Subsequently, a fifth illustrative embodiment is described. FIG. 16 depicts intensities of vibrations that are generated in the panel 10, in the fifth illustrative embodiment.

As shown in FIG. 16, in the fifth illustrative embodiment, for example, the operation surface 15 of the panel 10 is demarcated into areas A1 to A4. When a user contact position is detected in the area A1 of the areas A1 to A4, the driving unit 41 can set a vibration intensity of the area A1 to be higher than the areas A2 to A4 by appropriately controlling the vibrations of the respective vibration elements 14, for example. Thereby, in the area A1 in which the user contact position is detected, it is possible to effectively provide the haptic vibration to the finger 50 of the user U.

After the haptic vibration is over, the driving unit 41 may control the vibration of each vibration element 14 to generate the operation sound from the area (here, at least one area (for example, the area A4) of the areas A2 to A4), in which the vibration intensity is low upon the haptic vibration. Thereby, it is possible to early generate the operation sound subsequently to the haptic vibration while suppressing an influence of the haptic vibration on the vibration of generating the operation sound.

That is, since the areas A2 to A4 include parts except the user contact position, the vibration intensity upon the haptic vibration is lower than the area A1 including the user contact position. For this reason, a time period after the haptic vibration is over until the haptic vibration converges is shorter in the areas A2 to A4 than in the area A1.

Therefore, in the fifth illustrative embodiment, the operation sound is generated from the area (for example, the area A4), in which the haptic vibration converges early, of the operation surface 15 of the panel 10. In this way, according to the fifth illustrative embodiment, since the vibration of the operation sound is generated in the area (for example, the area A4), in which the haptic vibration is early stopped, of the panel 10, it is possible to suppress an influence of the haptic vibration on the vibration of generating the operation sound, and to early generate the operation sound subsequently to the haptic vibration. In the meantime, the area A1 is an example of the first area, and the areas A2 to A4 are examples of the second area.

In the meantime, the first to fifth illustrative embodiments may be appropriately combined. That is, for example, in a combination of the first and third illustrative embodiments, in the case of the usual user operation, for example, the sound signal may be output with being superimposed on the drive signal for vibration of the vibration elements 14, and in the case of the user operation for which the operation sound is required to be generated in a specific direction, the drive signal may be output with being modulated by the sound signal.

Also, the first to fifth illustrative embodiments may be combined depending on display contents of the display device 3. FIG. 17 depicts an example of a menu screen 60 that is to be displayed on the display device 3. As shown in FIG. 17, a slide button 61 and icon buttons 62, for example, are displayed on the menu screen 60.

The slide button 61 is a button for receiving an input operation of the user U by a slide operation, and is configured to receive a volume adjusting operation of an audio, for example. The icon button 62 is a button for receiving an input operation of the user U by a pressing operation, and is configured to receive an operation of selecting contents to be output from an audio, for example.

When the display contents of the display device 3 are contents shown in FIG. 17, the first and fourth illustrative embodiments can be combined, for example. That is, for example, when the slide operation is performed on the slide button 61, the sound signal may be output with being superimposed on the drive signal for vibration of the vibration elements 14, and when the pressing operation is performed on the icon button 62, the drive signal for vibration of the vibration elements 14 may be output, and the sound signal for operation sound may be output after the haptic vibration is over and the vibration convergence time period elapses. Thereby, it is possible to generate the haptic vibration and operation sound suitable for display contents of the display device 3, in the panel 10.

The additional effects and modified embodiments can be easily deduced by one skilled in the art. For this reason, the wider aspects of the present disclosure are not limited to the specific and representative illustrative embodiments as described above. Therefore, a variety of changes can be made without departing from the concept or range of the general inventions defined in the claims and equivalents thereof.

What is claimed is:

1. A control device comprising:
an operation detector configured to detect a user's operation on an operation surface of a panel, and
a driving unit configured to vibrate the panel by driving a vibration element attached to the panel,
wherein when the operation is detected by the operation detector, the driving unit combines a sound signal of sound, which is to be generated from the panel by vibration of the panel, with a drive signal for generating, in the panel, haptic vibration to provide the user with vibration of a haptic sense, and outputs a combined signal to the vibration element, thereby generating the haptic vibration and the sound in the panel.

2. The control device according to claim 1, wherein the driving unit is configured to superimpose and combine the sound signal with the drive signal.

3. The control device according to claim 1, wherein the driving unit is configured to divide the drive signal and the sound signal and to combine the signals so that the divided drive signal and sound signal are alternately output to the vibration element.

4. The control device according to claim 1, wherein the driving unit is configured to ultrasonically vibrate the panel and to generate the haptic vibration by the drive signal, and to combine the sound signal with the drive signal by modulating the drive signal with the sound signal.

5. A control device comprising:
an operation detector configured to detect a user's operation on an operation surface of a panel, and
a driving unit configured to vibrate the panel by driving a vibration element attached to the panel,
wherein when the operation is detected by the operation detector, the driving unit generates, in the panel, haptic vibration to provide the user with vibration of a haptic sense, and then vibrates the panel to generate sound from the panel when a predetermined time elapses after the haptic vibration is over.

6. The control device according to claim 5, further comprising a vibration state detector configured to detect a vibration state of the panel,
wherein the driving unit is configured to change the predetermined time on the basis of the vibration state of the panel detected by the vibration state detector.

7. The control device according to claim 5, wherein when the driving unit generates the haptic vibration so that a vibration intensity of a first area of the panel comprising a position at which the operation is detected is higher than a vibration intensity of a second area comprising a part except for the position at which the operation is detected, the driving unit generates the sound from the second area of the panel.

8. An input system comprising:
a panel having an operation surface;
a vibration element attached to the panel, and
a control device comprising an operation detector configured to detect a user's operation on the operation surface and a driving unit configured to vibrate the panel by driving the vibration element attached to the panel,
wherein when the operation is detected by the operation detector, the driving unit combines a sound signal of sound, which is to be generated from the panel by vibration of the panel, with a drive signal for generating, in the panel, haptic vibration to provide the user with vibration of a haptic sense, and outputs the combined signal to the vibration element, thereby generating the haptic vibration and the sound in the panel.

9. A control method comprising:
an operation detection process of detecting a user's operation on an operation surface of a panel, and
a drive process of driving a vibration element attached to the panel to vibrate the panel,
wherein the drive process comprises:
when the operation is detected in the operation detection process, combining a sound signal of sound, which is to be generated from the panel by vibration of the panel, with a drive signal for generating, in the panel, haptic vibration to provide the user with vibration of a haptic sense, and outputting the combined signal to the vibration element, thereby generating the haptic vibration and the sound in the panel.
